(19) United States
(12) Patent Application Publication
(10) Pub. No.: US 2010/0166928 A1
(43) Pub. Date: Jul. 1, 2010

(54) METHOD FOR PREPARING A HOT OR COLD DRINK BY INFUSION IN WATER, AND DEVICE IMPLEMENTING THE METHOD

(76) Inventors: Francis Stamm, Strasbourg (FR); Wei Cui Mo, Strasbourg (FR); Thierry Engel, Strasbourg (FR)

Correspondence Address: PEARNE & GORDON LLP, 1801 EAST 9TH STREET, SUITE 1200, CLEVELAND, OH, 44114-3108, US

(21) Appl. No.: 12/376,968

(22) PCT Filed: Aug. 20, 2007
(86) PCT No.: PCT/FR07/01385

§ 371 Date: Mar. 13, 2009

(30) Foreign Application Priority Data
Aug. 18, 2006 (FR) 0607390
Aug. 18, 2006 (FR) 0607391

(51) Int. Cl. A23F 3/06; A47J 31/44; A47J 31/00; A47J 31/06

(52) U.S. Cl. 426/435; 99/288; 99/282; 99/299

(57) ABSTRACT

A method and device for preparing a hot or cold drink by infusion of a product in water such as tea leaves for example, comprising a step of heating water to a determined temperature, then a step of mixing the leaves with the hot water, and finally a step of removing the infused leaves, comprising at least one step of immersing at least one element made of a porous material during the infusion; determining the temperature to which a predetermined volume of water must be heated; and determining the infusion time of the leaves in said volume of heated water; said infusion time in said volume of water is determined according to the characteristics of the infusions prepared with said leaves, the information relating to said leaves being recorded in a memory unit.

The present invention relates to a method for preparing a hot or cold drink by infusion of a product in water, and a device implementing said method. The invention will have numerous applications, more particularly in the field of making tea.

The preparation of tea by heating a volume of water, then steeping tea leaves in said hot water, is well known. After infusion, the tea leaves are removed by pouring the water and tea leaves through a filter, which retains said leaves.

It is also known to prepare tea by heating water, then pouring the hot water into a cup or similar, then immersing a diffuser sachet containing tea leaves in the hot water. The tea leaves then release their flavours, caffeine, etc. until their concentration is as desired by the consumer, the latter then removing the sachet from the water in order to consume the drink thus obtained.

These methods for making tea are empirical, such that it is difficult for the consumer to repeatedly prepare a drink having constant organoleptic characteristics. Furthermore, the organoleptic characteristics of the tea thus obtained, regardless of the quality of the leaves used, are too far removed from those of a tea prepared according to the Chinese tradition dating back almost a millennium.

Moreover, automation of the tea preparation method has already been devised.

This is the case, for example, in American U.S. Pat. No. 6,915,733 which describes a method for the preparation of an infused drink and a device for implementing said method.

This method involves measuring the quantity of water contained in a reservoir, then heating the water contained in the reservoir, then the product is infused in the hot water for a period of time calculated as a function of the measured quantity of water and/or the temperature of the water and/or the type of drink to be prepared.

Although this type of method makes it possible to prepare tea having constant organoleptic characteristics from one infusion to another, these organoleptic characteristics are too far from those of a tea prepared according to the Chinese tradition, such that the tea prepared according to this method is not satisfactory for connoisseurs of this drink.

A purpose of the invention is thus to improve on the tea preparation methods of the prior art, by proposing a method and a device making it possible to repeatedly prepare a hot or cold drink, such as tea for example, having organoleptic qualities similar to those of a tea prepared according to the Chinese tradition.

To this end, according to the invention a method for making a hot or cold drink is proposed, by infusing a product such as tea leaves for example in water, comprising a step of heating the water to a determined temperature, then a step of mixing the leaves with the hot water and finally a step of removing the infused leaves, comprising at least the following steps of:
determining the temperature to which a predetermined volume of water must be heated,
determining the infusion time of the leaves in said volume of heated water,

said method is noteworthy in that said infusion time in said volume of water is determined according to the characteristics of the infusions previously carried out with said leaves, as the information relating to said leaves is recorded in a memory unit.

The predetermined volume of water, heated to a determined temperature, is poured at a high flow rate onto the leaves to be infused, placed in a so-called infusion container.

Advantageously, prior to the infusion step, said method comprises at least one step of washing the leaves to be infused.

This washing step consists in mixing the leaves to be infused with a determined volume of water brought to a temperature above 60° C. for a time less than 5 seconds.

Preferably, the washing step consists in mixing the leaves to be infused with a determined volume of water brought to a temperature comprised between 60° and 100° C. for a time less than or equal to 2 seconds.

Moreover, information relating to the type of leaves to be infused is recorded in said memory unit beforehand.

Furthermore, information relating to the characteristics of the infusions carried out with said leaves is recorded in said memory unit beforehand.

Furthermore, the temperature to which the predetermined volume of water must be heated is determined by the type of leaves to be infused.

A further subject of the invention relates to a device for the preparation of a hot or cold drink by infusion of a product in water, comprising a water supply, heating means for heating the water, and a control unit cooperating with means for determining the temperature to which said volume of water must be heated and means for determining the infusion time of the product in said volume of heated water, noteworthy in that it comprises at least one infuser capable of receiving a determined volume of water and being driven in motion, said infuser comprising at least means for retaining the product to be infused and means for delivering the infusion.

Advantageously, the retaining means extend into a first, so-called retention and infusion volume V1, the water-heating means extend into the second, so-called heating volume V2, the movement of the infuser making it possible to transfer the determined volume of water at least from the volume V2 to the volume V1 then to the delivery means.

Preferably, the delivery means emerge between the volumes V1 and V2 and consist of a hole made in the wall of the infuser and emerging between the volumes V1 and V2.

Moreover, the retaining means are a filter basket capable of being introduced into the volume V1 through an aperture made in the wall of the infuser, said retaining filter basket being made of a porous material, preferably an earthenware material.

According to an advantageous characteristic, the infuser is mounted in rotation about an axis. This axis forms an angle α with the horizontal, preferably comprised between 20 and 45°.

Moreover, the device comprises a motor for driving the infuser in rotation about the axis, which is preferably outside the volume V2 in order to avoid any leakage problem.

The infuser has an overall spherical shape.

Furthermore, the device is constituted by a support in the general shape of a crescent moon, a first arm of which comprises a water reservoir and the second arm of which comprises at its free end the motor capable of driving the infuser in rotation about the axis.

Additionally, the first arm is detachable and comprises in its base a pump connected to a delivery pipe emerging at the free end of the reservoir, and a capacitive sensor, said pump and the capacitive sensor being connected to the control unit.

Other advantages and characteristics will be better understood from the following description of several embodiment variants given by way of non-limitative examples, of the method for the preparation of an infused hot drink and the device implementing said method according to the invention, with reference to the attached drawings in which:

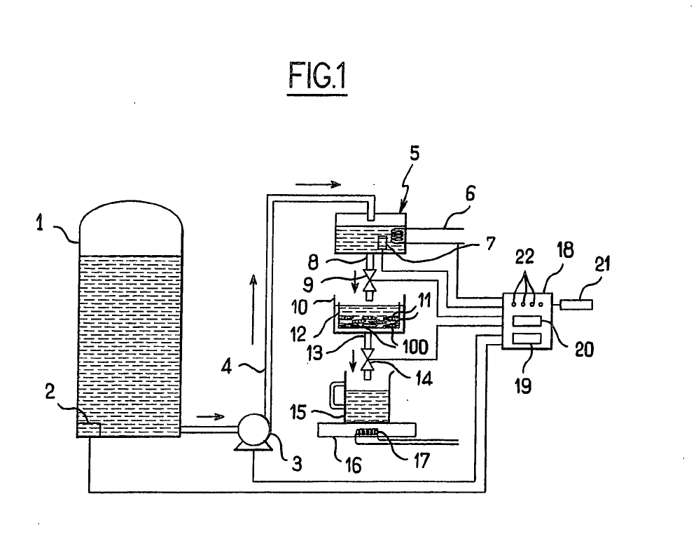

FIG. 1 is a diagrammatic representation of the device for the preparation of an infused drink according to the invention,

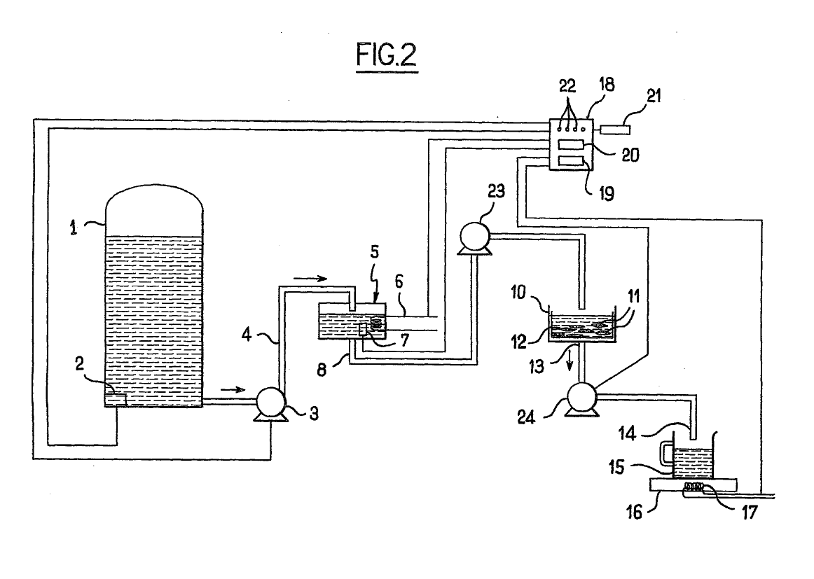

FIG. 2 is a diagrammatic representation of an embodiment variant of the device for the preparation of an infused drink according to the invention,

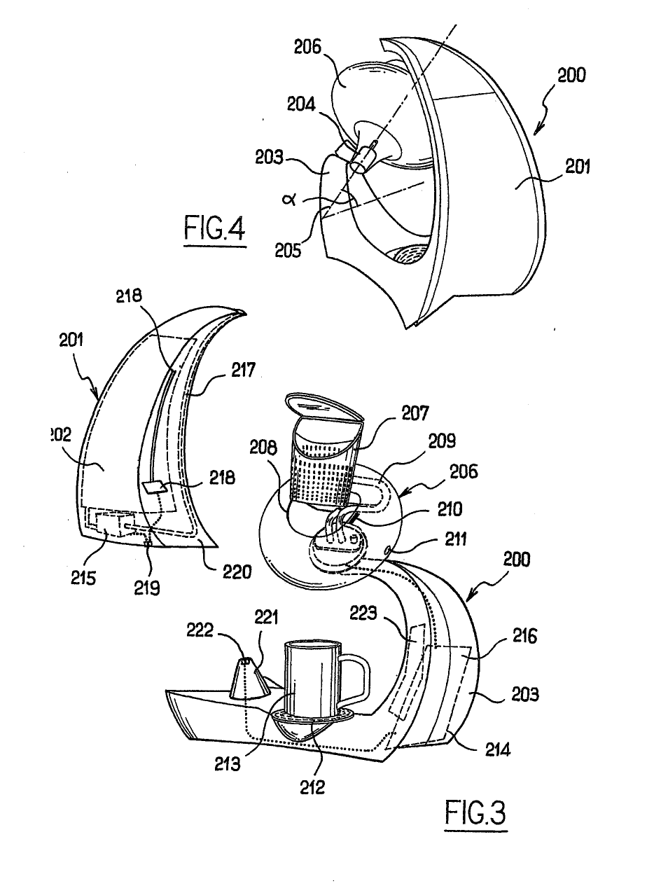

FIG. 3 is an exploded perspective view of an embodiment variant of the device for the preparation of an infused drink according to the invention,

FIG. 4 is a perspective view of the rear part of the embodiment variant shown in FIG. 3,

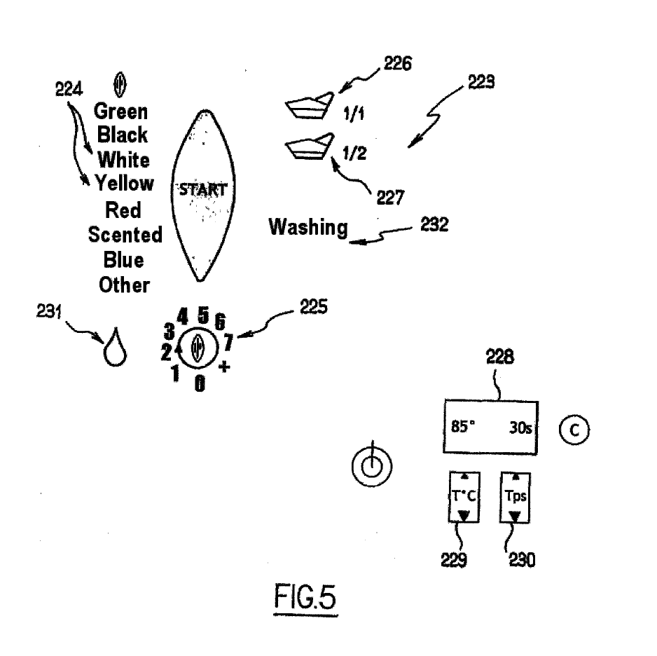

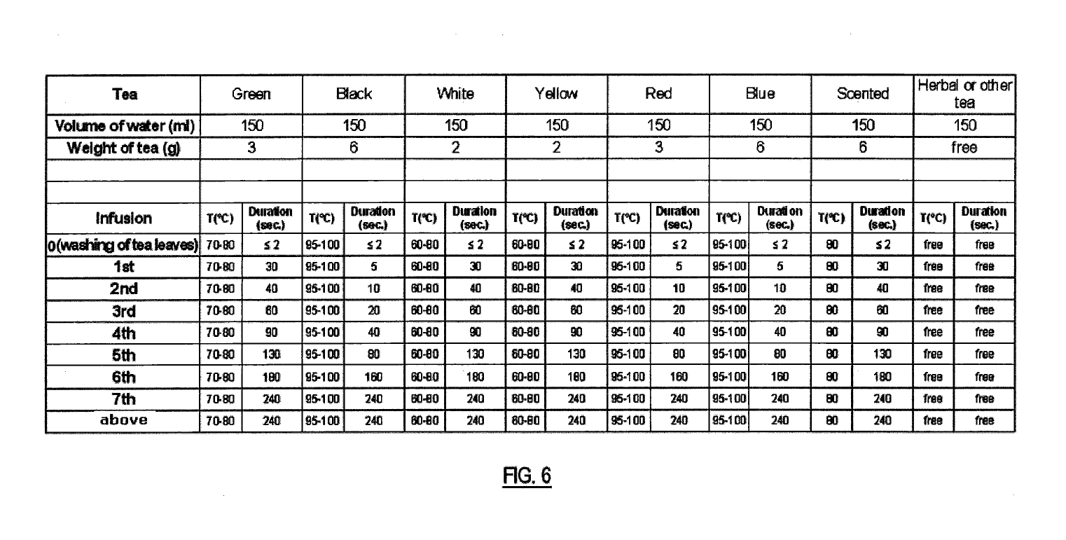

FIG. 5 is a diagrammatic representation of the user interface of the control unit of the variant embodiment of the device shown in FIG. 3,

FIG. 6 is a table showing the mass of the different types of tea for a determined volume of water, the washing and infusion temperatures as well as the washing and infusion times,

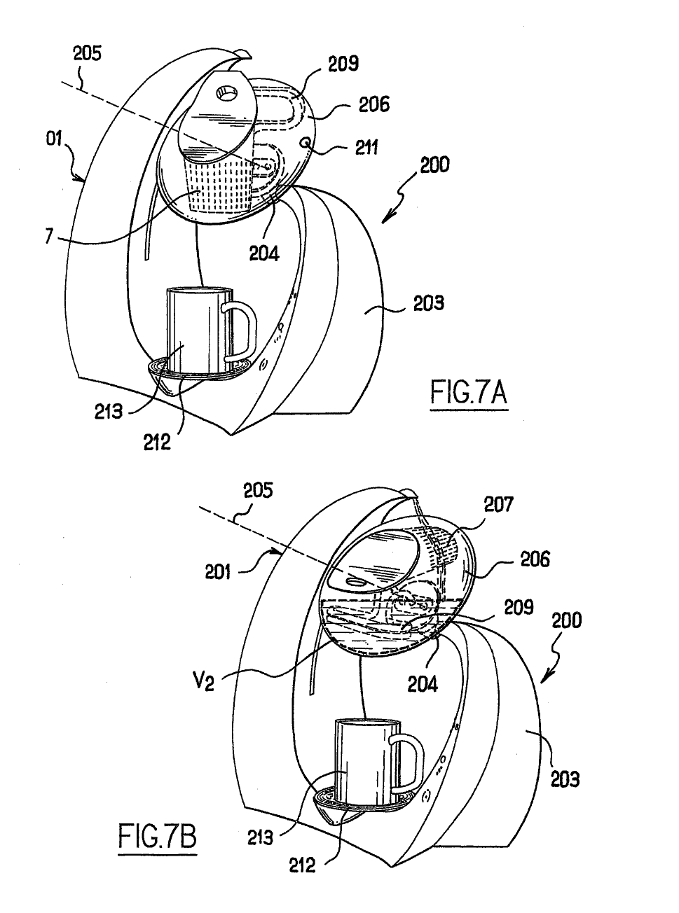

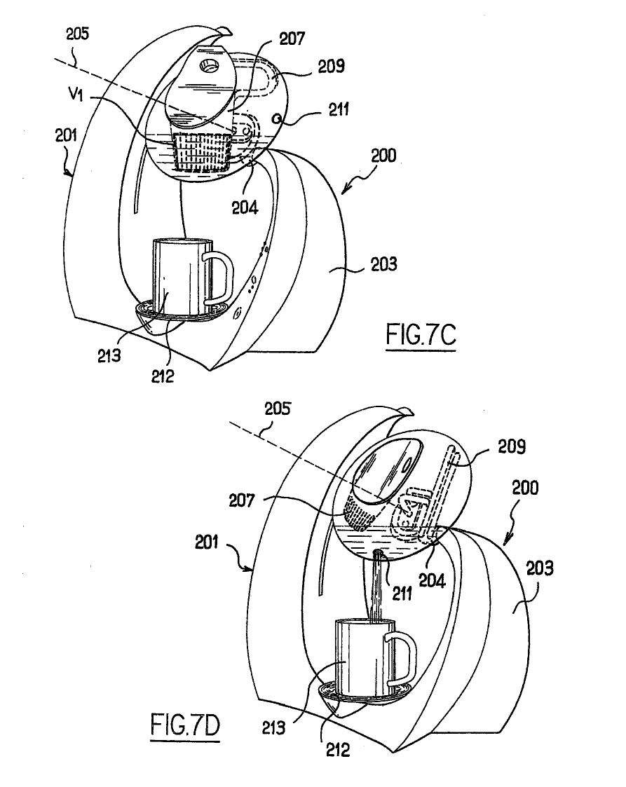

FIGS. 7A to 7D are diagrammatic representations of the device shown in FIG. 3 during the various steps of the method for making an infused drink according to the invention,

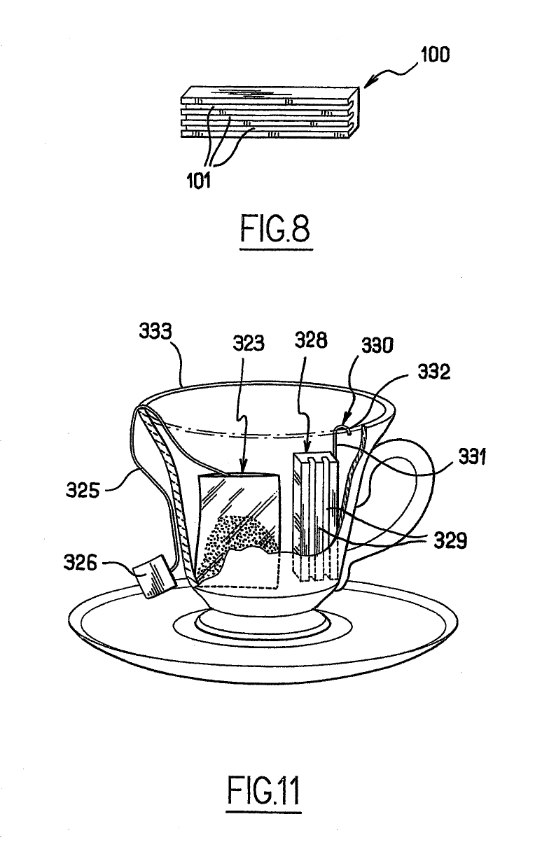

FIG. 8 is a perspective view of an element made of a porous material immersed in the infusion container of the device according to the invention shown in FIG. 1.

FIG. 9 is a perspective view of a diffuser sachet according to the invention,

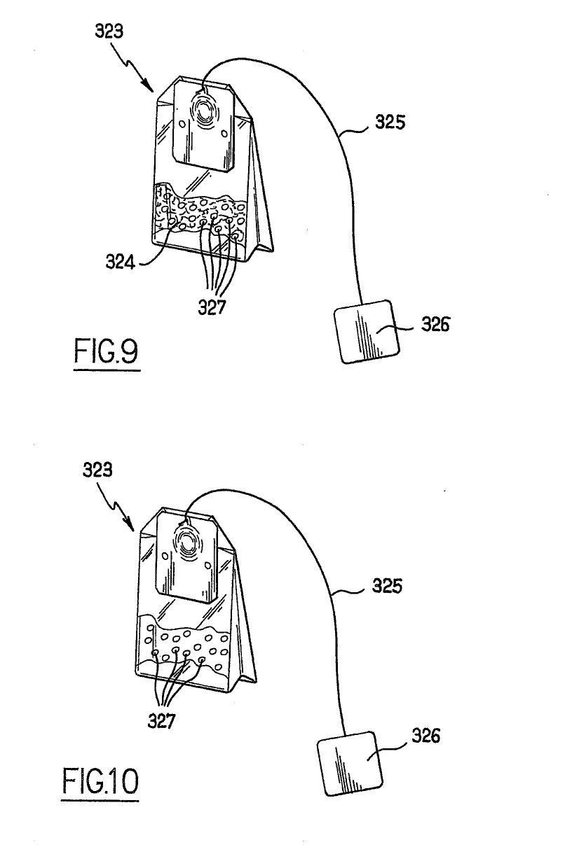

FIG. 10 is a perspective view of an embodiment variant of a diffuser sachet according to the invention,

FIG. 11 is a perspective cut-away view of a cup of tea equipped with an element made of a porous material according to the invention.

With reference to FIG. 1, the device according to the invention comprises a large-capacity water reservoir 1 comprising in its lower part a pressure sensor 2 which makes it possible to measure in real time the quantity of water present in said reservoir 1.

V=h·A (1)

and

P=ρ·g·h (2)

Where P represents the measured pressure
ρ represents the density of the water
g represents the earth's gravitational constant, and
h represents the height of the water in the reservoir 1.

By introducing the equation (1) into the equation (2) above, the following equation is obtained:

$$V = \frac{P . A}{p . g} \qquad ( 3 )$$

This equation (3) makes it possible to determine in real time the volume of water present in the reservoir 1.

The above equations correspond to a cylindrical reservoir 1 having a constant section. Of course, the reservoir 1 can have a variable section and a person skilled in the art will then adapt these equations.

According to an embodiment variant of the device according to the invention, the latter comprises a water reservoir 1 having a determined volume, such as the volume of water for the preparation of one or two cups of tea for example, and optionally comprising a graduation. In this embodiment variant, the device does not comprise a pressure sensor 2 for determining the quantity of water present in the water reservoir 1.

Moreover, the device comprises a pump 3 connected to a pipe 4, the ends of which open respectively at the lower end of the reservoir 1 and at the upper end of a first, so-called heating container 5, in order to transfer a determined volume of water from the reservoir 1 to said heating container 5 as will be detailed below.

Of course, the device can comprise several pipes 4 having a constant or variable section, without exceeding the scope of the invention.

Said heating container 5 comprises an electrical resistance heater 6 for heating the water and a temperature sensor 7, such as a thermocouple for example, for measuring in real time the temperature of the water contained in said heating container 5. The latter comprises in its lower part a discharge opening 8 connected to watertight opening and closing means 9, such as an electrical valve connected in a watertight manner to said opening 8, in order to allow the rapid discharge of the water heated in said heating container 5 to a second container called an infusion container 10 in which tea leaves 11 are previously placed.

It will be noted that the electrical valve 9 makes it possible to pour the hot water into the infusion container 10 at a high flow rate such that the water is poured in over a very short time, of the order of one or more seconds or less. This rapid pouring at a high flow rate achieves on the one hand, brewing of the tea leaves in the water, promoting a homogenous and rapid infusion of the tea and, on the other hand, precise control of the infusion time, the pouring of the water not being progressive. By high flow rate is meant a flow rate of the order of 150 ml in a time less than or equal to 2 seconds.

However, it will be understood that the water could be poured more slowly into the infusion container 10, which would require different infusion times, without exceeding the scope of the invention.

This infusion container 10 is positioned under the heating container 5, directly below the latter, and comprises filtering means 12, such as a filter basket retaining the tea leaves used for the infusion.

Said infusion container 10 is made of a non-porous material, such as a plastic material or stainless steel for example, and segments 100 of a porous material, preferably of an earthenware material, are positioned in said infusion container 10 such that said segments 100 made of porous material are immersed when the hot water is poured into the infusion container 10. These segments 100 made of porous material consist for example, with reference to FIG. 8, of single blocks having the overall shape of a parallelepiped, advantageously comprising grooves 101 in order to increase the exchange surface between said segments 100 and the infusion.

Moreover, each segment 100 advantageously comprises retaining means, not shown in the figures, for keeping the element(s) 100 immersed in the infusion container 10 and/or in the serving container 15.

These retaining means can consist of any retaining means well known to a person skilled in the art, such as a rod attached to said segment 100 and forming a hook at its free end.

It will be understood that the segments 100 can have any shape without exceeding the scope of the invention.

Said porous material retains in particular the tannin which diffuses into the water during infusion and a deposit of tannin is progressively formed with successive infusions. This tannin deposit significantly improves the organoleptic qualities of the infused tea. Furthermore, while the earthenware segments 100 are immersed in the infusion, particles of earthenware material dissolve in said infusion, giving said infusion organoleptic qualities similar to those of the tea made according to the traditional method of the tea masters.

Clearly, pouring the water at a high flow rate into the infusion container 10 can be replaced by any mechanical or hydraulic means capable of allowing the tea leaves to brew in the hot water when the latter is poured into the infusion container. These means can consist for example of means for stirring the water and/or means for agitating the filter basket 12.

Said infusion container 10 comprises in its lower part a second, so-called discharge opening 13 connected to second watertight opening and closing means 14, such as an electrical valve for example, in order to allow the infusion to be delivered into a container called a serving container 15 positioned under the infusion container 10 directly below the latter. This serving container 15 rests on a base 16 comprising heating means 17, such as an electrical resistance heater for keeping the infused tea at the appropriate temperature.

It will be understood that the heating means can be replaced by cooling means such as a Pelletier effect device for example, or any other equivalent means well known to a person skilled in the art.

The device according to the invention comprises moreover a control unit 18 connected to the pressure sensor 2 and to the temperature sensor 7. This control unit 18 comprises, on the one hand, a memory unit 19 in which data relating to the tea leaves placed in the infusion container 10 are recorded and, on the other hand, a firmware system such as a microprocessor 20 or a microcontroller which is connected to the memory unit, and in which algorithms are recorded constituting means for determining the temperature at which the volume of water must be heated and means for determining the infusion time of the product in said volume of heated water.

The device advantageously comprises a display screen 21 and buttons 22 for selecting information from the memory unit 19, relating in particular to the tea leaves. Said buttons 22 make it possible in particular to select the type of tea, the number of infusions as well as the number of cups. Said control unit 18 is moreover connected to the pump 3, to the heating means 6 of the so-called heating container 5, to the temperature sensor 7, to the pressure sensor 2, to the opening and closing means 9 and 14 and to the heating means 17 of the base 16 in order to control them.

The operation of the device according to the invention will now be explained with reference to FIG. 1.

A determined quantity of tea leaves 11 is placed in the retaining filter basket 12 of the infusion container 10. The control unit 18, by means of the microprocessor 20 and the memory unit 19, determines the quantity of water contained in the reservoir 1 which must be transferred into the heating container 5. This quantity of water depends on the type of tea leaves and their quantity. For example, the volume of water transferred into the heating container is 150 ml for 6 g of blue tea and/or black tea and 150 ml for 3 g of green tea.

Clearly, the quantity of water can depend on the number of cups desired and the quantity of tea to be placed in the retaining filter basket 12 of the infusion container 10 can be calculated in a similar way.

Once the required quantity of water has been determined, the control unit 18 actuates the pump 3 until the pressure sensor shows the following pressure P₂:

$${P}_{2} = {P}_{1} - \frac{( {V}_{1} - {V}_{2} )}{A} p . g$$

Where

P₁ is the pressure measured inside the reservoir 1 before pumping,

P₂ is the pressure measured inside the reservoir 1 after pumping,

V₁ is the volume of water contained in the reservoir 1 before pumping,

V₂ is the volume of water contained in the reservoir 1 after pumping.

The pump 3 is then stopped.

The control unit 18 actuates the electrical resistance heater 6 of the heating container 5 until the water contained in said heating container 5 reaches a determined temperature, said temperature being measured by the temperature sensor 7. Said temperature is determined beforehand by the means for determining the temperature of the control unit 18. This temperature depends on the type of tea leaves placed in the infusion container. For example, the temperature is 95° C. for blue tea, 80° C. for green tea and 95° C. for black tea.

When the water contained in the heating container 5 reaches said determined temperature, the control unit 18 actuates the electrical valve 9 in order to pour the hot water, in a very short time, into the infusion container 10.

After infusion of the tea leaves in the hot water for a determined so-called infusion time, said infusion time being determined by the control unit 18, the latter actuates the second electrical valve 14 in order to pour the tea into the container called the serving container 15, the tea leaves 11 remaining in the retaining filter basket 12. The infusion time is determined by the control unit, and more particularly by the means for determining the infusion time, and depends, on the one hand, on the type of tea leaves and, on the other hand, on the number of infusions already carried out with said tea leaves. For example, for blue tea, if the infusion time is approximately 5 seconds for the first infusion, it will be approximately 10 seconds for the second infusion, then approximately 20 seconds for the third infusion, etc. and for green tea, if the infusion time is approximately 30 seconds for the first infusion, it will be approximately 40 seconds for the second infusion, then 60 seconds for the third infusion, etc. The user can of course adapt these infusion times, to their taste in particular.

When the tea is poured into the serving container 15, the control unit actuates the electrical resistance heater 17 of the base 16 in order to keep the tea at the correct temperature suitable for consumption of the tea thus prepared.

According to an embodiment variant of the device according to the invention, with reference to FIG. 2, said device comprises all of elements of the device described previously with the exception of the electrical valves 9 and 14 which are replaced by a pump 23 and 24 respectively. Thus in contrast to the device described previously where the water is poured from the heating container 5 into the infusion container 10 then into the serving container 15 by gravity, implying that the infusion container 12 is situated above the serving container 15 and that the heating container 5 is situated above the infusion container 12, the use of pumps 23 and 24 for conveying the water from the heating container 5 into the infusion container 12 then into the serving container 15 makes it possible for the different containers 5, 12 and 15 to be placed in any position in relation to each other. Thus, the heating container is advantageously positioned beside the infusion container, thus facilitating access to said infusion container 12 from above in particular.

According to a preferred embodiment variant of the device according to the invention with reference to FIG. 3, the latter is constituted by a support 200 in the general shape of a crescent moon, a first arm 201 of which comprises the water reservoir 202 and the second arm 203 of which comprises, with reference to FIG. 4, a motor 204 capable of driving a so-called infuser element 206, having a generally spherical shape overall, in rotation about an axis 205, said axis 205 extending to the end of the second arm 203 at an angle α comprised between 1 and 179° to the horizontal, and preferably an angle α comprised between 20 and 45°.

It will be understood that said element 206 can be a shape of revolution (conical, ovoid, etc.) or any other shape such as a parallelepiped or tetrahedron, etc. without exceeding the scope of the invention.

Moreover, the motor 204 can drive the infuser 206 in rotation about the axis 205 by any means well known to a person skilled in the art, such as a worm and a toothed wheel for example.

This infuser 206 comprises two separate volumes, a first, so-called retention and infusion volume V1 (FIG. 7D) and a second, so-called heating volume V2 (FIG. 7B). Said infuser 206 comprises in the first volume V1 a detachable retaining filter basket 207 in which the tea leaves to be infused are placed. This retaining filter basket 207 is advantageously made of a porous material and preferably an earthenware material. Said retaining filter basket 207 is capable of being introduced into the infuser 206 through an aperture 208 made in the wall of the latter.

Of course, the retaining filter basket 207 can be replaced by any other equivalent retaining means, such as cartridges or in the form of tea pads, without exceeding the scope of the invention.

It will be noted that the axis 205 is outside the volume V2 and V1, i.e. it passes through neither the volume V2 receiving the water nor the volume V1, in order to avoid any leakage problem.

Moreover, said infuser 206 comprises in the second volume V2, means for heating and/or cooling the water 209, such as an electrical resistance heater for example, as well as a temperature sensor 210.

In order to allow delivery of the infusion, the infuser 206 comprises a delivery aperture 211 emerging between the volumes V1 and V2. This advantageous position of the delivery aperture 211 also makes it possible to avoid any leakage problem.

Of course, the delivery aperture 211 can be replaced by any delivery means well known to a person skilled in the art such as an aperture equipped with controlled and watertight sealing means, said means being capable of opening into volume V1 or V2.

Furthermore, the device comprises between the two arms 201 and 203 of the base 200, a stand 212 capable of receiving a cup 213 into which the tea is poured after infusion. Additionally, said stand 212 can advantageously comprise heating and/or cooling means, not shown in FIG. 3, in order to keep the infused tea at a temperature of approximately 50° C., which is the recommended temperature for drinking infusions in order to avoid any burning of the throat.

Moreover, said device comprises a control unit 214 connected to the temperature sensor 210, the water-heating means 209, the motor 204 and a pump 215 conveying the water contained in the reservoir 202 to the infuser 206 in particular. This control unit 214 comprises, on the one hand, a memory unit 216 in which data is recorded relating to the tea leaves placed in the retaining filter basket 207 and, on the other hand, a firmware system such as a microprocessor, or a micro-controller, connected to the memory unit 216, and in which algorithms are recorded constituting means for determining the temperature to which the volume of water must be heated and means for determining the infusion time of the product in said volume of heated water.

The arm 201 receiving the water reservoir 202 is advantageously detachable and comprises in its base the pump 215 connected to a delivery pipe 217 emerging at the free end of the reservoir 202, i.e. emerging at the level of the infuser 206 when the water reservoir 202 is in position. Furthermore, the reservoir 202 comprises a capacitive sensor 218 connected to contact connection means 219 placed at the base of a conical recess 220 made at the base of the arm 201 and capable of receiving a conical spigot 221 provided at its end with contact connection means 222 connected to the control unit 214. The pump 215 is also connected to the contact connection means 219 of the reservoir 202. Thus when the control unit 214 actuates the pump 215 in order to pour water into the infuser 206 through an aperture, not shown in the figures, made in the wall of the infuser 206, the capacitive sensor 218 transmits information on the volume present when pumping starts. When the capacitive sensor 218 informs the control unit 214 that a determined volume of water has been poured into the infuser 206, said control unit 214 stops the pump 215.

Moreover, when the capacitive sensor 218 shows that no water, or insufficient water, is left in the reservoir 202 to produce the number of cups required by the user, the control unit 214, on the one hand, prevents any new infusion until the reservoir 202 has been filled and, on the other hand, emits a visible or audible signal indicating the insufficiency or absence of water to the user so as to enable him to fill the reservoir 202.

Additionally, the arm 201 can comprise means for filtering the water, not shown in the figures, such as carbon filters or similar, constituted by a removable cartridge or any other filtering means well known to a person skilled in the art. Said filtering means can for example, be mounted on the delivery pipe 217 close to the free end of the arm 201.

With reference to FIG. 5, the device advantageously comprises an interface 223 comprising buttons 224 for selecting the type of tea leaves introduced into the retaining filter basket 207, a screen 225 displaying information on the number of infusions already made and the one in progress (1 infusion corresponding to a cycle of 150 ml) and buttons 226, 227 for selecting the quantity of tea to be made: one cup as default (150 ml), half a teapot (button 227) corresponding to 2 cups or a whole teapot (button 226) corresponding to 4 cups. The interface 223 also comprises a display screen 228 and buttons 229, 230 for selecting data relating to the temperature and duration of the infusion. In this way, the user can optionally change the default temperature and/or the infusion time, according to his preferences and/or the product infused.

The washing step preceding the first infusion can thus for example be dispensed with by selecting a zero infusion time with the button 230.

This step of washing the tea leaves is carried out before the first infusion, i.e. when new tea leaves have been placed in the retaining filter basket 207, and involves mixing the leaves to be infused with a determined volume of water corresponding to a cup, i.e. approximately 150 ml, brought to a temperature above 60° C. for a time less than or equal to 5 seconds. Preferably, this washing step involves mixing the leaves to be infused with a volume of water of approximately 150 ml brought to a temperature comprised between 60° and 100° C. for a time less than or equal to 2 seconds. All the elements of temperature and duration of this washing step are indicated in the table shown in FIG. 6. The water from this washing step is collected in the cup 213 which the user empties before the start of the first infusion.

Finally, the interface 223 comprises a warning light 231 indicating that the water reservoir 202 has insufficient water to make the quantity of tea required and a button 232 making it possible to wash the infuser 206.

The operation of the device according to the invention will now be explained with reference to FIGS. 3 and 7A to 7D.

With reference to FIGS. 3 and 7A, water is introduced into the water reservoir 202 beforehand and tea leaves are placed in the retaining filter basket 207 which is then placed in the volume V1 of the infuser 206. Then, on the interface 218, the user selects the type of leaves introduced (green, black, white tea, etc.), the number of cups (1 cup as default, ½ teapot=2 cups and 1 teapot=4 cups). The control unit 214 then determines the temperature and the infusion time. All of the values for temperature and infusion time are shown in the table in FIG. 6.

However, the user can select the temperature and the duration of infusion himself according to personal taste, by pressing buttons 229, 230.

With reference to FIG. 7B, the infuser 206 is driven in rotation about its axis 205, then the water is introduced into said infuser 206, more specifically, the water is introduced into the volume V2 of the infuser 206, without passing through the volume V1 of said infuser 206. The water is not then in contact with the tea leaves placed in the retaining filter basket 207 which is then situated in the upper part of the infuser 206. The water is then heated until it reaches the temperature determined by the control unit 214.

When the water reaches the required temperature, with reference to FIG. 7C, the infuser is driven in rotation about its axis 105, with a rotation of +180° (in order to avoid the water passing through delivery aperture 211), i.e. with a clockwise rotation of 180°, in such a way that the retaining filter basket 207 and the tea leaves are immersed in the hot water. The rotation of the infuser 206 is limited by any appropriate means such as position sensors for example. It will be noted that the rotation of the infuser 206 and the immersion of the retaining filter basket 207 in the water results in agitation promoting a homogeneous mixture of the tea leaves in the water. Furthermore, the infuser 206 can undergo low-amplitude rotations, preferably resulting in a swinging movement of the infuser 206, for the duration of the infusion, thus promoting the production of a perfectly homogeneous mixture.

When the duration of the infusion has ended, with reference to FIG. 7D, the infuser 206 is once again driven in rotation about its axis 205, with a rotation of +90°, in order to deliver the infusion through the delivery aperture 211 which is then situated at the lowest point of the infuser 206 and at the level of the cup 213 placed on the base 210.

The step of washing the leaves is normally carried out on each new introduction of tea leaves and in a similar way, with reference to FIGS. 7B to 7D, to the preparation of an infusion, the infusion time being less than or equal to 2 seconds.

Moreover, it will be noted that that the infuser 206 can be cleaned by introducing a volume of water greater than the predetermined volume of water corresponding to a cup then by heating the water to a temperature of approximately 100° C., the retaining filter basket 207 preferably being emptied beforehand.

It will be understood that the water reservoir 202 can be replaced by a continuous water supply through the mains for example, the capacitive sensor 218 then being replaced by a flow meter.

Moreover, the device can advantageously comprise a drawer for introduction of the tea leaves, previously packaged in a bag, a capsule or similar, or not packaged.

Furthermore, the heating means 209 can be placed in the arm 201, in the reservoir 202 or at the outlet from the latter, without exceeding the scope of the invention.

It will be noted that the infuser 206 can have any shape and that the volumes V1 and V2 can be separated by a wall. Depending of the shape of the infuser 206, the angles of rotation may be different and the rotations of the infuser 206 may optionally be replaced by translational movements or any other movement allowing the water to pass from volume V1 to volume V2 and vice versa without exceeding the scope of the invention.

The device can comprise means for reading an identification code of the quantity and/or of the type of the tea leaves placed in the infusion container, said reading means being connected to the control unit 18. The identification code can be any identification code well known to a person skilled in the art such as a barcode, an electronic chip, a magnetic or optical code, raised or intaglio printing for example, the reading means being an optical, magnetic, electronic, mechanical or similar reader.

With reference to FIG. 9, the invention also relates to a diffuser sachet 323 containing a product 324, such as tea leaves for example, capable of infusing in hot or cold water.

The diffuser sachet consists for example of a “bilobate” type filter sachet. A bilobate sachet is formed from a sheet of filter paper, which is rolled by a continuous spool, folded and joined by the free longitudinal edges in order to form a tubular segment, the segment is folded into a W in the centre of the tubular sheet in order to former opposite lobes or chambers intended to contain the infusion product. The two lobed tubes are brought close to each other and their openings are closed by an operation which comprises the actual closing and the attachment at one of the ends of a thread 325 attached to a label 326.

Said diffuser sachet 323 also contains granules 327 made of a porous material mixed with said product 324. These granules 327 are preferably made of an earthenware material in order to allow a release of flavour making it possible to prepare a tea, the organoleptic qualities of which are similar to those of the tea prepared by the method of the tea masters.

It will be understood that the diffuser sachet can be any type of filter sachet or equivalent without exceeding the scope of the invention.

According to an embodiment variant of the diffuser sachet 323 according to the invention, the granules are replaced by at least one element of any shape made of a porous material, and preferably an earthenware material.

According to another embodiment variant of the diffuser sachet 323 according to the invention, with reference to FIG. 10, the latter only contains granules 327 made of a porous material, and preferably an earthenware material.

It is clear that the granules 327 can be replaced by at least one element of any shape made of a porous material, and preferably an earthenware material.

Said diffuser sachet 323 containing only granules 327 is immersed simultaneously or successively to the immersion of a diffuser sachet containing tea in hot or cold water contained in a cup or similar and can advantageously be used several times.

A last subject of the invention relates to, with reference to FIG. 11, an element 328 made of a porous material capable of being immersed in an infusion.

Said element 328 is a single block having the overall shape of a parallelepiped, advantageously comprising grooves 329 in order to increase the exchange surface with the infusion and made of an earthenware material.

The element 328 comprises, moreover, retaining means 330 consisting, for example, of a rod 331 attached to element 328 and folded at its free end in order to form a hook 332 capable of being supported on the edge of a cup 333 or similar in order to hold said element 28 in the infusion container.

This element 328 is, in the same way as previously, immersed simultaneously or successively to the immersion of a diffuser sachet 323 containing tea in hot or cold water contained in a cup 333 or similar and can advantageously be used several times.

Finally, it is clear that the device can be adapted for the preparation of any hot or cold drink, prepared by infusion of a product in water, such as a herbal tea for example, and that the examples that have just been given are only particular illustrations by no means limitative with regard to the fields of application of the invention.

1. Method for making a hot or cold drink, by infusing a product in water, such as tea leaves for example, comprising a step of heating the water to a determined temperature, then a step of mixing the leaves with the hot water, and finally a step of removing the infused leaves, comprising at least the steps of:
determining the temperature to which a predetermined volume of water must be heated,
determining the infusion time of the leaves in said volume of heated water,
characterized in that said infusion time in said volume of water is determined according to the characteristics of the infusion(s) carried out with said leaves, the information relating to said leaves being recorded in a memory unit.

2. Method according to claim 1, characterized in that the predetermined volume of water, heated to a determined temperature, is poured at a high flow rate onto the leaves to be infused, placed in a so-called infusion container.

3. Method according to claim 1, characterized in that, prior to the infusion step, it comprises a step of washing the leaves.

4. Method according to claim 3, characterized in that the washing step consists in mixing the leaves to be infused with a determined volume of water brought to a temperature above 60° C. for a time less than 5 seconds.

5. Method according to claim 4, characterized in that the washing step consists in mixing the leaves to be infused with a determined volume of water brought to a temperature comprised between 60° and 100° C. for a time less than or equal to 2 seconds.

6. Method according to claim 1, characterized in that information relating to the type of leaves to be infused is recorded in said memory unit beforehand.

7. Method according to claim 1, characterized in that information relating to the number of infusions carried out with said leaves is recorded in said memory unit beforehand.

8. Device for the preparation of a hot or cold drink, by infusion of a product in water, comprising a water supply, heating means for heating the water and a control unit cooperating with means for determining the temperature to which said volume of water must be heated and means for determining the infusion time of the product in said volume of heated water, characterized in that it comprises at least one infuser capable of receiving a determined volume of water and being driven in motion, said infuser comprising at least means for retaining the product to be infused and means for delivering the infusion.

9. Device according to claim 8, characterized in that the retaining means extend into a first, so-called retention and infusion volume V1, the means for heating the water extend into the second so-called heating volume V2, the movement of the infuser making it possible to transfer the determined volume of water at least from volume V2 to volume V1 then to the delivery means.

10. Device according to claim 9, characterized in that the delivery means emerge between the volumes V1 and V2.

11. Device according to claim 10, characterized in that the delivery means consist of a hole made in the wall of the infuser and emerging between the volumes V1 and V2.

12. Device according to claim 8, characterized in that the retaining means consist of a filter basket capable of being introduced into the volume V1 through an aperture made in the wall of the infuser.

13. Device according to claim 12, characterized in that the retaining filter basket is made of a porous material.

14. Device according to claim 13, characterized in that the retaining filter basket is made of an earthenware material.

15. Device according to claim 8, characterized in that the infuser is mounted in rotation about an axis.

16. Device according to claim 15, characterized in that the axis forms an angle α with the horizontal.

17. Device according to claim 16, characterized in that the angle α is comprised between 20 and 45°.

18. Device according to claim 15, characterized in that it comprises a motor for driving the infuser in rotation about the axis.

19. Device according to claim 15, characterized in that the axis is outside the volume V2.

20. Device according to claim 8, characterized in that the infuser has a spherical shape overall.

21. Device according to claim 18, characterized in that it is constituted by a support in the general shape of a crescent moon, a first arm of which comprises a water reservoir and the second arm of which comprises at its free end the motor capable of driving the infuser in rotation about the axis.

22. Device according to claim 21, characterized in that the first arm is detachable and comprises in its base a pump connected to a delivery pipe emerging at the free end of the reservoir, and a capacitive sensor, said pump and the capacitive sensor being connected to the control unit.
